(19) United States
(12) Patent Application Publication
(10) Pub. No.: US 2010/0065792 A1
(43) Pub. Date: Mar. 18, 2010

(54) BIODEGRADABLE DIELECTRIC FLUID

(76) Inventor: Jesus Izcara Zurro, Bilbao (ES)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/531,681

(22) PCT Filed: Mar. 16, 2007
(86) PCT No.: PCT/ES07/00148

§ 371 Date: Sep. 16, 2009

(51) Int. Cl. H01B 3/20

(52) U.S. Cl. 252/574; 252/578; 252/579; 252/575

(57) ABSTRACT

The present invention belongs to the field of dielectric fluids for electric systems, it specifically relates to a biodegradable dielectric fluid that is highly resistant to oxidation consisting of an oil or a mixture of vegetable oils with a very high oleic acid content which substantially conserve all their natural tocopherols and containing a metal deactivator, as well as to its use for insulating and cooling electrical equipment.

### FIELD OF THE INVENTION

The present invention belongs to the field of dielectric fluids for electric systems, it specifically relates to a biodegradable dielectric fluid that is highly resistant to oxidation consisting of an oil or a mixture of vegetable oils with a very high oleic acid content which substantially conserve all their natural tocopherols and containing a metal deactivator, as well as to its use for insulating and cooling electrical equipment.

### BACKGROUND OF THE INVENTION

Dielectric fluids which are used in the electrical industry generally consist of gases or liquids the most important mission of which is to achieve the electrical insulation between live parts, as well as to serve as a cooling means. The liquids which are used as dielectric media can have different origins.

The liquids most used as a dielectric fluid are mineral oils derived from petroleum. The considerable use of mineral oils is due to their low cost and easy availability, as well as to their dielectric properties, cooling properties, to the low viscosity at high temperatures and to their excellent behavior at very low temperatures. Likewise, they have a high oxidation stability. But on the other hand, mineral oils involve the drawback that due to their chemical composition, their biodegradability is very low, whereby a spillage of said oil can cause damage in the ecosystem and can remain in the environment for many years. Likewise, mineral oils have a high combustion power and have a very low fire point, whereby they involve a high risk in the event of fire and/or explosion.

Current regulations furthermore require any dielectric fluid intended for use as a coolant to not be classified as inflammable. According to the use of the fluid and the degree of risk, one or more safety measures can be required. A recognized safety option is to substitute mineral oils with less inflammable or non-inflammable liquids. The less inflammable liquids must have a fire point equal to or greater than 300° C. Thus, dielectric liquids with a high fire point (equal to or greater than 300° C.), such as for example silicone oils, high molecular weight hydrocarbons (HMWHs) or synthetic esters are occasionally used. However, silicone oils and high molecular weight hydrocarbons (HMWHs) are characterized, like mineral oils, by their null or low biodegradability. Likewise, all these liquids have a higher cost than that of mineral oils.

Among the alternatives to the aforementioned liquids which have appeared in recent years, natural esters from vegetable oils must be emphasized. Natural esters are obtained from oils with a plant origin through suitable refining and purification processes.

Vegetable oils are essentially made up of triacylglycerols and of other components in a lower proportion such as for example monoacylglycerols, diacylglycerols, free fatty acids, phosphatides, sterols, oil-soluble vitamins, tocopherols, pigments, waxes, long-chain alcohols etc.

Triacylglycerols occurring in vegetable oils are triesters formed by three fatty acids chemically bonded to glycerin. The general formula of a triacylglycerol is:

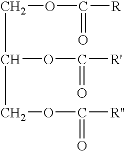

wherein R, R^{I}, R^{II} can be the same or different fatty acids normally with C₁₄ to C₂₂ carbon chains and with unsaturation levels of 0 to 3.

The main differences between the different vegetable oils are caused by the different fatty acid contents present in the composition of their triacylglycerols.

There are several fatty acids, including myristic, palmitic, stearic, oleic, linoleic, linolenic, arachidic, eicosenoic, behenic acid, erucic, palmolitic, docosadienoic, lignoceric, tetracosenoic, margaric, margaroleic, gadoleic, caprylic, capric, lauric, pentadecanoic and heptadecanoic acids. They differ from one another by the number of carbon atoms and by the number of unsaturations (carbon-carbon double bonds).

The three fatty acids in a triacylglycerol molecule can all be the same or can be two or three different fatty acids. The fatty acid composition of triacylglycerols varies between plant species and less between strains of a particular species. The vegetable oils derived from a single strain essentially have the same fatty acid composition in their triacylglycerols. Each triacylglycerol has unique properties depending on the fatty acids that it contains. For example, some triacylglycerols are more susceptible to oxidation than others. In this sense, the oils formed by triacylglycerols with mono-unsaturated (with a single C═C double bond) fatty acids have a higher oxidation stability than oils formed by triacylglycerols with fatty acids with two or three carbon-carbon double bonds. Likewise, the oils formed by triacylglycerols with saturated (no C═C double bond) fatty acids will have an even higher oxidation stability than mono-unsaturated fatty acids but their minimum pour point would be much higher.

The greatest advantages of the use of vegetable oils as dielectric fluids are summarized in their excellent biodegradability, their obtaining from renewable natural sources, their non-toxicity, their high fire point (≅360° C.) and their low cost compared to other options with a high fire point such as synthetic esters. All the environmental, health and safety trends have reinforced the idea of using dielectric fluids based on vegetable oils.

However, vegetable oils or their derivatives are not free of problems in their application as dielectric fluids.

For example, the freezing point (or minimum pour point) of vegetable oils is a property to be taken into account. The freezing point defines the temperature at which a liquid passes to the solid state, with the consequent loss of cooling properties. According to the only existing standard specifying the properties of a vegetable oil for its use as a dielectric fluid, American standard ASTM D6871-03, the freezing point must be −10° C. at most. It is therefore important for the dielectric fluid to be based on vegetable oils ensuring that it remains as a flowing liquid even when the dielectric fluid is subjected to moderately low temperatures (less than −15° C.). Additives are usually used to reduce the freezing point and achieve dielectric liquids that are more resistant to the low temperatures. For example additives such as PMA (polymethacrylate), oligomers and polymers of polyvinyl acetate and/or acrylic oligomers and polymers, diethylhexyl adipate, polyalkylmethacrylate have been used.

Other problematic factors in the properties of vegetable oils are the presence of water, microbial growth, the presence of solids, etc.

But in fact one of the most important problems of vegetable oils is that of oxidation. Vegetable oils are normally susceptible to polymerization when they are exposed to oxygen. The exposure to oxygen activates the non-saturated bonds present in the fatty acids of the triacylglycerols of the oils, causing oxidative polymerization of the oil, with potentially adverse effects on the properties of the actual dielectric fluid. Their susceptibility to oxidation is an important obstacle to their use as a dielectric.

The problem of the oxidation of oils has usually been solved by means of adding synthetic antioxidant oils such as BHA (butylated hydroxyanisole), BHT (butylated hydroxytoluene), TBHQ (tertiary butylhydroquinone), THBP (tetrahydrobutrophenone), ascorbyl palmitate (rosemary oil), propyl gallate etc. On the other hand, the problem of the oxidation of dielectric fluids based on vegetable oils is emphasized in electrical apparatuses due to the catalytic activity of copper or of other metals present in this type of apparatus.

All the aforementioned problems have been previously set forth in patents EP1365420, U.S. 2004069975, U.S. Pat. No. 6,613,250, U.S. Pat. No. 6,340,658, U.S. Pat. No. 6,645,404, U.S. Pat. No. 6,280,659, JP2000090740 and JP2005317259, with different solutions.

The inventors of the present invention propose a dielectric liquid providing an alternative technical solution to the problem of oxidation and providing very advantageous features to the liquid for its application as an insulator and coolant of electrical apparatuses.

The solution to the problem of the oxidation of the dielectric fluid of the invention comes from the use of oils with a very high oleic acid content, and obtained by refining processes which allow conserving the natural tocopherols present in said vegetable oils in a high percentage, given that traditional refining processes involve the loss of a considerable amount of their tocopherols. An example of a suitable process for the purposes of the present invention is described in patent U.S. Pat. No. 5,928,696. The inventors have discovered that certain vegetable oils with very high oleic acid contents and low linoleic contents and which conserve their natural tocopherols to a great extent have enough antioxidant power to prevent having to add antioxidant additives, such as for example non-biodegradable synthetic antioxidant additives, as was being done up until now. Tocopherols, however, in addition to being substantially biodegradable, are substances which are naturally present in the composition of oils and which have important antioxidant properties. There are four types of tocopherols, α-, β-, γ- and δ-tocopherol, having different antioxidant power and which are present in different proportions depending on the type of vegetable oil and on the variety from which it is obtained.

Furthermore, to solve the problem of the acceleration of oxidation due to the catalytic activity of metals, the inventors of the present invention provide the incorporation of metal deactivators such as derivatives of triazole, of benzotriazole, of dimercaptothiadiazole, etc

### OBJECT OF THE INVENTION

A first object of the invention is a biodegradable dielectric fluid free of added antioxidant additives, synthetic or not, comprising an oil or a mixture of vegetable oils with an oleic acid (C18:1) content greater than 75%, a natural tocopherol content greater than 200 ppm and incorporating a metal deactivator additive in a proportion less than 1% by weight. This dielectric fluid will hereinafter be called fluid of the invention.

Another object of the invention is the use of the fluid of the invention as an insulator and coolant of electrical apparatuses or equipment.

### DETAILED DESCRIPTION OF THE INVENTION

In a first aspect, the invention relates to a biodegradable dielectric fluid free of synthetic antioxidant additives added thereto comprising an oil or a mixture of vegetable oils with an oleic acid (C18:1) content greater than 75%, characterized by having a natural tocopherol content greater than 200 ppm and a metal deactivator additive in a proportion less than 1%.

In a preferred embodiment of the invention the natural tocopherol content is greater than 300 ppm and in an even more preferred embodiment it is greater than 400 ppm.

In a preferred embodiment of the invention the oleic acid content of the oil or vegetable oils is greater than 80% and in an even more preferred embodiment said content is greater than 90%.

Since in most applications of dielectric liquids the latter are usually in contact with metals, the dielectric fluid includes as an additive a metal deactivator to prevent the copper or other metal in contact with the oil from acting as a catalyst of the oxidation reactions thereof. Therefore, it is suitable to include in the composition of the dielectric liquid a metal deactivator such as for example any derivative of triazole, of benzotriazole or of dimercaptothiadiazole.

Furthermore, the dielectric fluid of the invention preferably comprises:
a) a linoleic acid (C18:2) content less than 3.5%
b) a linolenic acid (C18:3) content less than 1%
c) a palmitic acid (C16:0) content less than 4%
d) a stearic acid (C18:0) content less than 2.5%

Oils or mixtures of sunflower, rapeseed, soybean, cotton, jojoba, safflower, olive or olive-pomace oils with a high oleic content are especially suitable for their use as a dielectric fluid according to the present invention, although the preferred embodiment of the invention involves the use of high oleic sunflower oil. These oils, in addition to high oleic acid levels, naturally have a large amount of tocopherols which are mostly lost in normal refining processes. The refining of said oils according to methods capable of conserving their natural tocopherols to a great extent contributes to these oils being very suitable for their use as dielectric fluids without the risk of oxidation thereof. For example, the methods described in patent U.S. Pat. No. 5,928,696 allow obtaining oils with tocopherol concentrations greater than 400 ppm and with low phosphatide, free fatty acid and wax contents.

The oil or oils resulting from the mentioned methods can be subjected to a subsequent vacuum distillation process, using a combination of heat and vacuum, to eliminate most of their moisture. The dehumidification of the oil is necessary due to the fact that the oil can have an initial moisture level making it unsuitable to be used as a dielectric liquid. The vegetable oil is thus processed for the purpose of eliminating the excessive moisture to a level less than 50 ppm.

The oils thus obtained are characterized by having induction times longer than 25 hours in the Rancimat test (EN 14112) and a biodegradability index greater than 99% after 21 days (CEC-L-33-A-93). In other words, dielectric fluids with a high quality and excellent yield satisfying or exceeding the safety standards and which in turn are not toxic, are harmless to the environment and have a lower cost than other dielectric fluids are achieved by using the mentioned oils or their mixtures.

The dielectric fluid of the invention can further have additional additives depending on the type of application to which it is going to be subjected.

For applications in environments in which the temperature can drop to temperatures less than −15° C., it is recommendable to further add an additive to reduce the freezing point, preferably of the polyalkylmethacrylate type. The use of these additives allows obtaining dielectric fluids with freezing points equal to or less than −18° C.

The second aspect of the invention relates to the use of the dielectric fluid of the invention as an insulator and coolant of electrical apparatuses or equipment. As was mentioned above, the fluid can be used in switchgear and/or protection cubicles, transformers, self-protected transformers with current-limiting fuses or transformation centers with multiple switchgear elements and multiple protection devices.

### PREFERRED EMBODIMENT OF THE INVENTION

The special fatty acid composition of the triacylglycerols of the vegetable oils used and the process for obtaining them, as well as their final drying, confer to the resulting liquid specific physical properties making it particularly suitable for its use as a dielectric liquid.

A preferred example of dielectric liquid to which this invention relates has the following composition:

Sunflower oil with a high oleic acid content with:
a) natural tocopherols

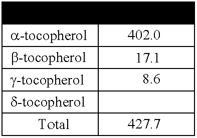

b) triacylglycerols, with the following fatty acid composition

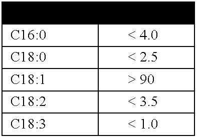

c) 5000 ppm of a metal deactivator additive derived from dimercaptothiadiazole (Additin RC 8210 of Rhein Chemie) corresponding to less than 1% by weight of the total of the composition.

The dielectric liquid with the composition indicated above has the following properties:

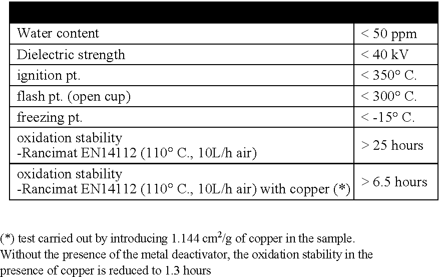

Optionally, for some more demanding embodiments, in places where the electrical equipment is subjected to extremely low temperatures, the pour point can be further reduced by adding an additive to the oil to obtain a lower freezing point. Commercially available additives which are compatible with vegetable oils, such as for example the product known as Viscoplex 10-310, can thus be used.

1. Biodegradable dielectric fluid free of synthetic antioxidant additives added thereto comprising an oil or a mixture of vegetable oils with an oleic acid (C18:1) content greater than 75%, with a natural tocopherol content greater than 200 ppm and a metal deactivator additive in a proportion less than 1%.

2. Dielectric fluid according to claim 1, comprising an oil or mixture of oils with an oleic acid (C18:1) content greater than 80%.

3. Dielectric fluid according to claim 1, comprising an oil or mixture of oils with an oleic acid (C18:1) content greater than 90%.

4. Dielectric fluid according to claim 1, characterized in that the natural tocopherol content is greater than 300 ppm.

5. Dielectric fluid according to claim 1, characterized in that the natural tocopherol content is greater than 400 ppm.

6. Dielectric fluid according to claim 1, characterized in that it has a fire point greater than 350° C.

7. Dielectric fluid according to claim 1, characterized in that the oil or vegetable oils comprise:
a) a linoleic acid (C18:2) content less than 3.5%
b) a linolenic acid (C18:3) content less than 1%
c) a palmitic acid (C16:0) content less than 4%
d) a stearic acid (C18:0) content less than 2.5%

8. Dielectric fluid according to claim 1, characterized in that the dielectric fluid comprises an additive to reduce the freezing point.

9. Dielectric fluid according to claim 8, characterized in that the additive is of the polyalkylmethacrylate type.

10. Dielectric fluid according to claim 8, characterized by having a freezing point equal to or less than −18° C.

11. Dielectric fluid according to claim 1, wherein the metal deactivator is a derivative of triazole, of benzotriazole or dimercaptothiadiazole.

12. Dielectric fluid according to claim 11, wherein the metal deactivator is a derivative of dimercaptothiadiazole.

13. Dielectric fluid according to claim 1, characterized in that the oil or mixture of vegetable oils can be of sunflower, rapeseed, soybean, cotton, jojoba, safflower, olive or olive-pomace oil with a high oleic content.

14. Method of using a dielectric fluid comprising applying the dielectric fluid according to any of claim 1, 6-8, 10, 11 or 13 as an insulator and coolant to electrical apparatuses or equipment.
